(19) United States
(12) Patent Application Publication
(10) Pub. No.: US 2013/0109335 A1
(43) Pub. Date: May 2, 2013

(54) Cam profile in the periphery of a rotating wheel transmitting power via a compresible rope or cable

(71) Applicant: Frederic Mason Mathews, Mediapolis, IA (US)

(72) Inventor: Frederic Mason Mathews, Mediapolis, IA (US)

(73) Assignee: Frederic Mason Mathews, Mediapolis, IA (US)

(21) Appl. No.: 13/317,767

(22) Filed: Oct. 26, 2011

(51) Int. Cl. F16H 53/00; F02F 3/00; H04B 1/08; D03D 49/00; B63B 21/04; F16H 55/00; B25J 19/00

(52) U.S. Cl. 455/130; 74/567; 474/152; 123/193.1; 74/490.04; 139/97; 114/218

(57) ABSTRACT

A drive power transmission element in the form of a wheel adapted to be mounted on a non-rotatable axel where the wheel has a peripheral surface of a geometric envelope or cam profile developed on a mathematical formula being bounded and rectifiable and therefore having Defined length and area receiving a flexible power transmission element such as a rope of solid braided nylon cord locked by compression rather than friction operating circumferentially, where for example as a boat cleat or in radial operation, ideal in general for transmission of mechanical power directly applied to various mechanical linkages or where the operable dynamic forces of compression may operate as force fields or mechanical structures in lighter than air envelopes, parachutes, hydraulic nozzles, pumps, internal combustion engines, envelopes for jet engines, fiber optics, designs of optical lenses, and related applications to move or contain mass and energy over distance.

### SUMMARY OF THE INVENTION

An object of the invention is to provide a drive power transmission element based on physical vectors of compression on a flexible drive element to effect the movement or displacement of mass and energy over a distance subject to defined rather than undefined vector co-ordinates.

Another object of the invention is to provide exactly defined surfaces as to location, tolerance, and linear measurement of length and space for calculations of clearance, machining speed, cutting tool application, constructing tools used in lathe work, drilling, grinding, polishing and finishing.

Another very important object of the invention is to provide symmetry of mass to effect calculations of dynamic balance of the rotating drive element. Forging of the rotating drive element, orientation to surface grinding, determination of radial moment of gyration, location and addition of mass to drilled holes for balancing all depend on defined geometry of the power transmission element's distribution of total mass.

An additional object of the invention of very special importance is the required tolerance in terms of machinist tolerance requirements, workability of the machine requires that the curvature of the cam profile or geometric envelope be true to itself, a ribbon on a graph one hundredth of an inch wide containing all points of the curve that is plus-minus one two hundredth of an inch to transmit power via a one quarter inch solid braided nylon cord as opposed to a machinist tolerance of plus-minus five ten thousandth's of an inch make possible mechanical construction by a machinist of minimal or beginning skill.

### BACKGROUND OF THE INVENTION

1. Field of the Invention

The present invention generally relates to a power transmission element based on a mathematically formulated cam profile or geometric envelope incorporating a drive connection between a rotatable wheel and a flexible drive or driven member in the form of a compressible line or rope where a locking action is provided by compression in the tapering periphery of the wheel which is either circumferential or radial where the locking action is accomplished by surfaces and area beneath the surfaces which are mathematically bound and rectifiable, the relation between the statistical distribution of the energy of compression and its dynamic position are clearly and absolutely mathematically Defined.

2. Description of Prior Art

Transmission of power in determination of physical vectors as to dynamic balance of a rotating disk and vectors at the radial moment of gyration could not be as precisely calculated in case of prior art U.S. Pat. No. 4,077,271 and No. 5,415,593 because the geometry of the physical surfaces at the tapering periphery of the power drive rotating wheel were bounded and non-rectifiable thus clearly and absolutely mathematically Undefined.

### BRIEF DESCRIPTION OF THE DRAWINGS

FIG. 1 shows the Cam Profile fundamental to everything claimed in the entire patent application. It is a projection of a right cone of infinite altitude on a finite line, defined in claim 1. as to the method of its geometric construction. The foundational means of determining its blue printable structure are illustrated in FIG. 2. The hidden points on the non-rectifiable changing slope of the fifth dimensional trochoidal curve are exactly defined in quadratic form and a first in the five thousand fields of all higher mathematics. FIG. 3 shows a machine element 10, the overall invention, in the form of a wheel to be fixed to a rotatable axle, where the edge of the wheel 5 is shown, comprising a pulley 12 with a tapering groove 14 to engage a flexible power transmission element or rope 16 to transmit mechanical power. FIG. 4 shows a side view of a pulley 12 and tapering groove 14 where a locking action of a rope has a radial orientation. FIG. 5 shows a groove tapering on one side and flat on the other, where FIG. 6 shows a groove tapering on both sides. FIG. 7 shows a circumferential orientation tapering clockwise and counterclockwise to transmit power in either clockwise or counterclockwise directions.

### DRAWING DESCRIPTION

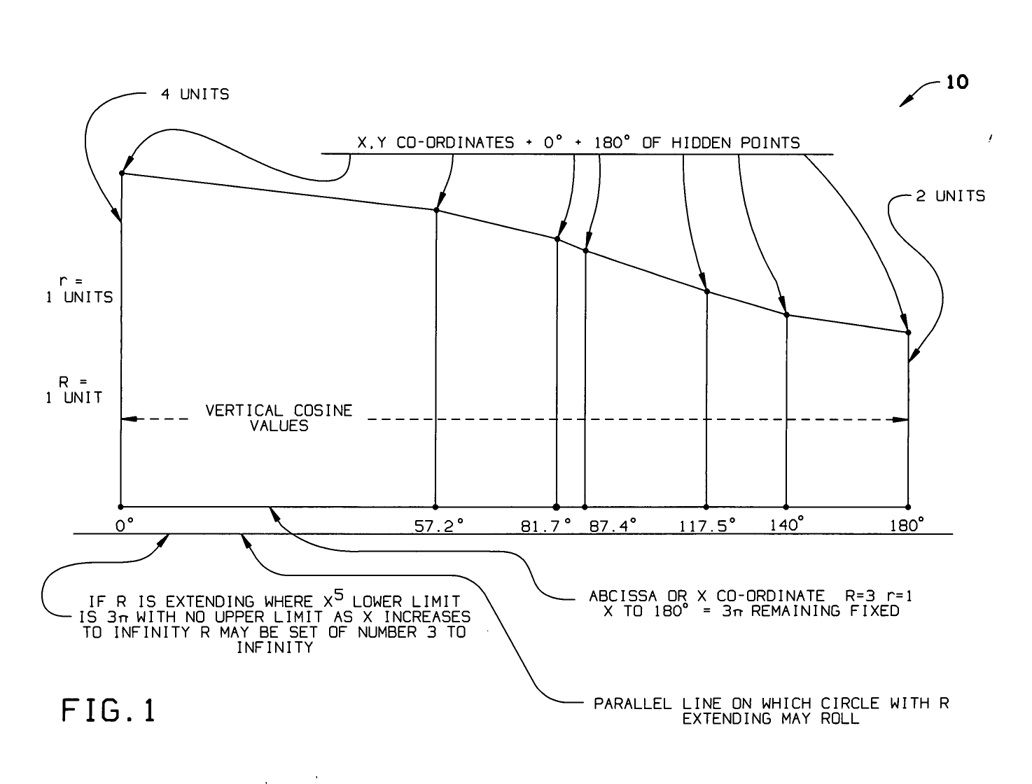

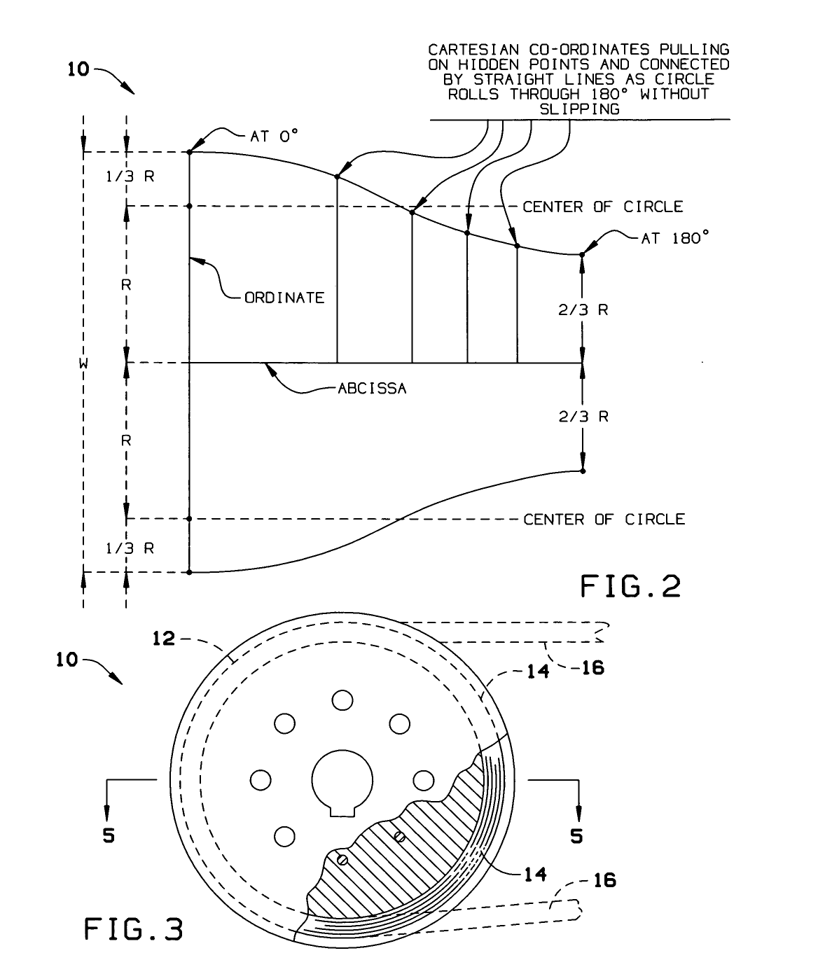

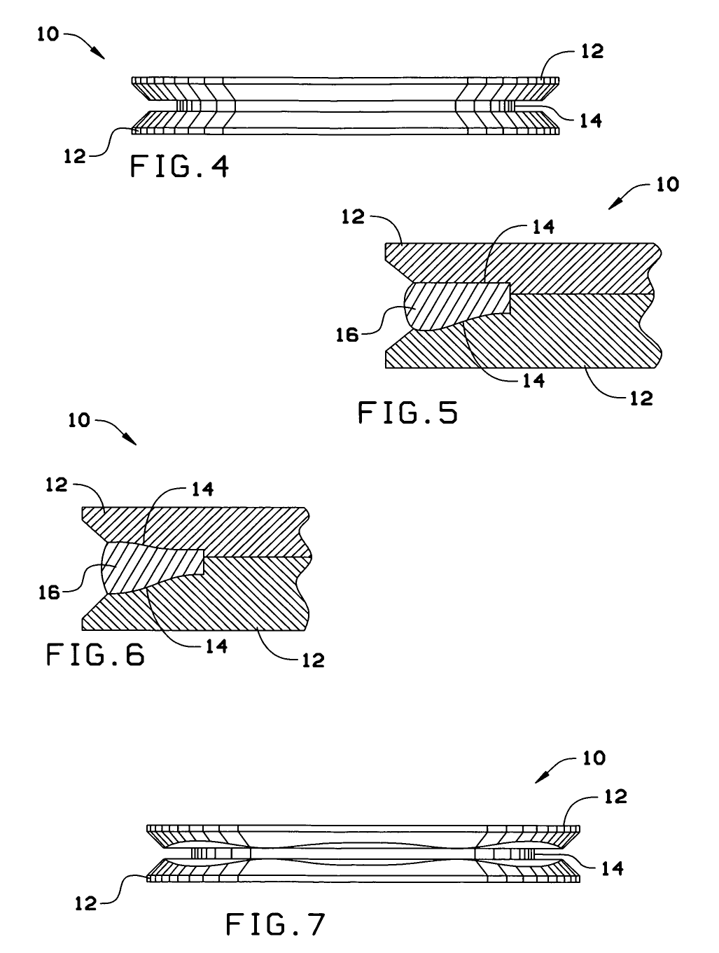

FIG. 1: is a schematic diagram of the invention 10.

FIG. 2: is a schematic diagram of the invention 10.

FIG. 3: is a side view of the invention 10.

FIG. 4: is a top view of the invention 10.

FIG. 5: is a section detail view of the invention 10 along line 5-5 in FIG. 3.

FIG. 6: is a section detail view of the invention 10.

FIG. 7: is a top view of the invention 10.

### DESCRIPTION LIST

10: is the overall invention.
12: is the pulley.
14: is the groove.
16: is the belt.

### DETAILED DESCRIPTION OF THE INVENTION

The invention is based on the mathematics of the light cone with a vertex at infinity, the famous problem of a right cone of infinite altitude on a finite base. The solution to this geometric is addressed in U.S. Pat. No. 4,077,271 and U.S. Pat. No. 5,415,593 where the cam profile or geometric envelope forming the periphery of the power transmission element is of a bounded and non-rectifiable trochoidal mathematical curvature. The difference in the new patent application is radically different mathematically, the difference being that the energy (statistical) and position (mechanical or dynamic) are absolutely defined as to co-ordinates, length, area and distribution of mass. The formula to find the ordinates and abscissa's of the trochoid at points from zero to one hundred and eighty degrees of angle theta are for the ordinates cosine theta plus three and for the abscissa's sine theta plus sine theta divided by one hundred and eighty degrees times three pi. The collection of points generating the ordinates in ranges defining the mathematically variable changes in value of one or more decimal places to the right of the decimal are determined. The difference of the end of the ranges from there beginnings where angle theta at the end of the ranges is determined forms a list of values of given magnitude. The greatest five magnitudes are selected and the points at zero and one hundred eighty degrees are also selected. The values of the abscissa and the ordinate simultaneously determine the Cartesian co-ordinates FIG. 2. of the “hidden points” at angle theta. The “hidden points” are connected by bounded and rectifiable simple straight lines FIG. 1. The end points of the straight lines break the whole trochoid curve onto segments FIG. 2. All points on the linear segments other than there end points have no points in common with all points on the trochoidal segments other than their end points FIG. 1. and FIG. 2. The tapering groove has a minimum length on the abscissa of pi R equal to three pi with no maximum length FIG. 1. The tapering groove may also have a constriction of its greatest diameter of from one half to zero.

A single scale drawing clearly illustrates this and is fundamental to every machine element covered by the patent.

FIG. 2. shows a side of the wheel. FIG. 4. shows a Peripheral view of the wheel with a radial orientation. FIG. 5. shows the tapering groove with a flat side, FIG. 6. Shows a tapering groove with a taper on both sides. FIG. 7. Shows a peripheral view of the wheel of a circumferential orientation of the tapering groove allowing power to be transmitting in both clockwise and counterclockwise directions.

Tolerance in machining is greatly reduced from five ten thousandth's to one two hundredth of an inch. Simple magnification makes a tolerance visible to the naked eye. The curve must be true to itself, its form not distorted, graphically all points on the cam profile must fall on a ribbon one hundredth inch wide, where the cam profile locks a one quarter inch diameter solid braided nylon cord.

Lathes are expensive and tightness in machinist terms is difficult and impractical to maintain. Metal of extreme hardness impervious to wear is required. Fitting the work piece of the power transmission element which is to be set on the axel of a heavy duty grinder or any rotational mounting turning at a very low R.P.M., removing excess material and then grinding the wheel's periphery with a special cam profile grinding bit of special properties as to tolerance, form, grain size, hardness and tensile strength are the best mode and the preferable means of production of an unconventional and clearly non-standard product.

Construction of the precision grindstone bit on a metal stem should be cast with an extremely fine grit and hard, high tensile resinous binder. A sheet or flat metal drill bit on a metal stem should be constructed and placed in the chuck of a drill press or drill featuring very low R.P.M. A cup of very hard frozen wax mounted on a drill press, where the drill bit can be lowered to peel out a mold for the grindstone bit in the wax where the casting must be refrigerated and allowed to harden as well as solidify accomplishes the first step in construction. When this is accomplished and wax removal is to be accomplished it is obvious to anyone skilled in the art of wax casting that in thermodynamics moving from frozen to vapor state using hot blown air cleanly removes the wax from the casting.

The hard metal periphery of the power transmission element should be hardened above the level of general machinability and ground, polished, and finished for high tolerance and wear.

What is claimed:

1. A defined mechanical cam profile or geometrical dynamic mechanical envelope constituting a machine element generated by a point r one unit from the center of a circle of radius R equal to three units where the circle rolls from zero through one hundred and eighty degrees without slipping, generating a collection of points on a trochoid curve where the formula for the curves co-ordinates are formulated by ordinates of cosine theta degrees times r equal to unity plus R equal to three and the abscissa's formulated by sine theta degrees times r equal to unity plus theta degrees divided by one hundred eighty degrees times R multiplied times pi, where R is equal to a set of values of three to infinity, where the collection of points generating the ordinates in ranges defining the mathematically variable changes in value of one or more decimal places to the right of the decimal place have a difference of the end of the ranges from the value of their beginnings constituting a magnitude of mathematical value at theta degrees of angle at the end of the ranges which when forming a basis for list of values in order of magnitude and concomitantly determining the generation of a list of values on the abscissa thereby generating defined co-ordinate points consisting of a minimal number of five in addition to co-ordinates of zero and one hundred and eighty degrees, falling on the trochoid which when connected by bounded and rectifiable lines or curves having no points on these lines or curves other than their end points falling on the trochoid are thus being bounded and rectifiable, where the entire cam profile or geometric envelope has an area of compression equal to or less than one half the maximum of the tapering periphery of the cam profile or geometric envelope,
where a cam profile or geometric envelope having a defined mechanical geometric form to which mechanical vectors of force are applicable to produce a machine element to transmit power via a compressible rope, cable, strand, or filament, or
where a gas, liquid, solid, glass, or plasma state containing a created area of space encompassing mechanical force or energy exists in order to function dynamically as a machine element, or where the generation of an energy field being electromagnetic, gravitational, inertial, or thermodynamic moves mass or energy over a distance.

2. Use of the cam profile or geometric envelope in claim 1. as a boat cleat such as used to anchor a boat or a naval vessel to a wharf, or in parallel under stress, strain, compressed load and positive locking action as a mechanism or form to encase or deform optical fiber bundles for general transmission of light energy over distance.

3. Use of the cam profile or geometric envelope in claim 1. to mathematically define an envelopment creating the configuration of a balloon, blimp, dirigible, or combination of any two or more of the three.

4. Use of a rotating member in claim 1. on a driven axel in the form of a wheel having in the wheel's periphery a cam profile or geometric envelope to provide positive drive power transmission via a compressible drive member for use in the fishing or related industry for clearly established application in the working equipment of nets, traps, trawling, bait lines, harvesting algae, pulling undersea cable lines, telephone lines, or functionally related applications on a driven axel where the specific need for a rewind drum is eliminated and where the driven axel may be connected to a driving axel via a compressible drive member powered, preferably by a hydraulic motor where the specific need to relieve strain, shock, wear, shearing, and vibration on gears, frictional drives, and direct drive motors, and where thermal and pressure factors may be reduced or eliminated.

5. Use of a rotating member in claim 1. where the tapering periphery effecting the locking action generating the transmission of power is wound on an axel in a spiral resembling the spiral of at twist drill.

6. Use of the rotating power transmission element in claim 1. where mechanical action on the flexible power transmission element is used to control the warp feed in weaving for improvement in fabric quality over machine or hand weaving in conjunction with either and to produce a locking element to draw or tense the weft thread through the warp.

7. Use in the configuration of the piston and cylinder of an internal combustion engine, or the geometry of a rotary, gas turbine, jet aircraft engine, rocket nozzle, or hydraulic pump of the cam profile or geometric envelope in claim 1.

8. Use of the power transmission elements in claim 1. in any form to formulate and control the mechanical linkage via flexible cable of robotic parts and arms of robots, cyborgs, mechanical men, and artificial limbs.

9. Use of the cam profile or geometric envelope in claim 1. to define the geometry of centrifugal inserts.

10. Use of a rotating member in the form of a wheel driving a flexible drive element, described in claim 1. in the form of an endless belt connecting a driving axel with the axel of the rotor of a centrifuge to produce elastic stretch without any slippage without respect to the load applied in order to maximize sedimentation.

11. Use of the cam profile or geometric envelope in claim 1. to form a shape for a shape charge for use in the application chemical and metachemical, thermodynamic reactions.

12. Use of the cam profile or geometric envelope to define the geometric shape of the cats whisker crystal used in radio transmission basically as a simple radio receiver.

13. A special cam profile or geometric envelope in the form of a Brachistochrone connecting to the tapering periphery, as claimed in the claim 1, of a rotating drive element in the form of a wheel transmitting power via the compression of and action by a flexible drive element in the form of a rope or cable.
